(19) United States
(12) Patent Application Publication
(10) Pub. No.: US 2026/0133561 A1
(43) Pub. Date: May 14, 2026

(54) INFORMATION PROCESSING DEVICE, INFERENCE DEVICE, MACHINE LEARNING DEVICE, INFORMATION PROCESSING METHOD, INFERENCE METHOD, AND MACHINE LEARNING METHOD

(71) Applicant: REVOX Corporation, Shizuoka-shi, Shizuoka (JP)

(72) Inventors: Kazuho Saeki, Yokohama-shi, Kanagawa (JP); Ryuichi Sato, Tokyo (JP); Shingo Tanaka, Tokyo (JP); Satoshi Fujii, Tokyo (JP)

(73) Assignee: REVOX Corporation, Shizuoka-shi, Shizuoka (JP)

(21) Appl. No.: 19/118,007

(22) PCT Filed: Jul. 4, 2024
(86) PCT No.: PCT/JP2024/024158

§ 371 Date: Apr. 3, 2025

(30) Foreign Application Priority Data
Sep. 21, 2023 (JP) 2023-156559

(51) Int. Cl. G05B 19/418; G06Q 30/0283

(52) U.S. Cl. CPC G05B 19/4183; G05B 19/41885; G06Q 30/0283

(57) ABSTRACT

Problem: To provide an information processing device capable of accurately generating machining information for a new machined product without relying on the knowledge and experience of a skilled worker. Solution to Problem: An information processing device (2) includes a feature acquisition unit (203B) configured to input input information based on new machined product information into a feature inference model (220) to acquire a feature of the new machined product information, a similar machined product information extraction unit (203C) configured to extract, from a database (210) in which existing machined product information and machining information are registered in association with each other, a plurality of sets of the existing machined product information that are similar to the new machined product information on the basis of the feature of the new machined product information, a machining information inference model learning unit (204) configured to perform machine learning on a machining information inference model (221) by using a plurality of sets of learning data configured of the input information based on the existing machined product information and the machining information associated with the existing machined product information, and a machining information generation unit (205A) configured to input input information based on the new machined product information into the machining information inference model (221) to generate the machining information for the new machined product information.

### TECHNICAL FIELD

The present invention relates to an information processing device, an inference device, a machine learning device, an information processing method, an inference method, and a machine learning method.

### BACKGROUND OF INVENTION

Processing companies that accept requests for manufacturing machined products are often given drawings related to a new machined product by a client and asked to submit an estimate on the basis of the drawings before the start of production. In this case, the estimate has conventionally been drafted by a skilled worker relying on their knowledge and experience. In order to reduce the labor involved and avoid being too dependent on any one worker, a method has recently been proposed to support some of the work related to the estimate process by using an inference model that uses machine learning.

For example, Patent Document 1 discloses a method of generating a similarity judgment model in advance by machine learning using existing drawing data related to an existing machined product stored in a database; when new drawing data related to a new machined product is input, using the similarity judgment model to output a score for individual categories of the new drawing data; and extracting the existing drawing data belonging to the category with the highest score.

Incidentally, in the above method, only the existing drawing data that is classified into the category to which the new drawing data is predicted to belong is extracted, and the similarity judgment model does not predict machining information corresponding to when the new machined product is machined according to the new drawing data. Therefore, even with this method, the creation of estimates has to rely on the knowledge and experience of a skilled worker.

### Prior Art

### Patent Literature

Patent Document 1: JP 2021-022330 A

### SUMMARY OF INVENTION

### Problem to be Solved by Invention

The present invention was made in view of the above problem, and an object of the present invention is to provide an information processing device, an inference device, a machine learning device, an information processing method, an inference method, and a machine learning method capable of accurately generating machining information for a new machined product without relying on the knowledge and experience of a skilled worker.

### Means for Solving the Problem

In order to achieve the object described above, an information processing device according to an aspect of the present invention includes:
a new machined product information acquisition unit configured to acquire new machined product information including drawing data and incidental information of a new machined product;
a feature acquisition unit configured to input feature inference model input information based on at least the drawing data of the new machined product information acquired by the new machined product information acquisition unit into a feature inference model to acquire a feature of the new machined product information;
a similar machined product information extraction unit configured to extract, from a database in which a plurality of sets of existing machined product information including drawing data and incidental data of an existing machined product and machining information corresponding to when the existing machined product is machined according to the existing machined product information are registered in association with each other, a plurality of sets of the existing machined product information that are similar to the new machined product information on the basis of the feature of the new machined product information acquired by the feature acquisition unit;
a machining information inference model learning unit configured to cause a machining information inference model to learn, by machine learning, a correlation between machining information inference model input information and the machining information by using a plurality of sets of learning data configured of the machining information inference model input information based on the existing machined product information extracted by the similar machined product information extraction unit and the machining information associated with the existing machined product information; and
a machining information generation unit configured to input machining information inference model input information based on the new machined product information acquired by the new machined product information acquisition unit into the machining information inference model that has been caused to learn by the machining information inference model learning unit to generate the machining information for the new machined product information.

### Effect of the Invention

With the information processing device according to an aspect of the present invention, existing machined product information that is similar to new machined product information is extracted by the similar machined product information extraction unit based on the features of the new machined product information, and machine learning of the machining information inference model is performed using learning data suitable for the new machined product. Therefore, compared to the case where the similarity between the new machined product and existing machined product is not considered, the inference accuracy of the machining information inference model can be improved because it is less affected by existing machined products whose characteristics differ significantly from those of the new machined product. Therefore, it is possible to accurately generate machining information for a new machined product without relying on the knowledge and experience of a skilled worker.

Problems, configurations, and effects other than those described above will become clear in the following description of the embodiments for implementing the present invention.

### BRIEF DESCRIPTION OF THE DRAWINGS

FIG. 1 is an overall configuration diagram of an example of an estimate creation support system 1 according to an embodiment of the present invention.

FIG. 2 is a diagram showing an example of various data related to a new machined product 10.

FIG. 3 is a diagram showing an example of various data related to an existing machined product 11.

FIG. 4 is a block diagram showing an example of an information processing device 2.

FIG. 5 is a functional illustration of an example of a feature inference model learning unit 202.

FIG. 6 is a functional illustration of an example of a similar machined product search processing unit 203.

FIG. 7 is a functional illustration of an example of a machining information inference model learning unit 204.

FIG. 8 is a functional illustration of an example of an estimation support processing unit 205.

FIG. 9 is a hardware configuration diagram showing an example of a computer 900.

FIG. 10 is a flowchart showing an example of the operation (information processing method) of the information processing device 2.

### EMBODIMENTS FOR IMPLEMENTING THE INVENTION

The following is a description of embodiments for implementing the present invention with reference to the drawings. In the following description, the scope necessary for explanation to achieve the object of the present invention will be described schematically, explanation will focus on the scope necessary for the explanation of relevant parts of the present invention, and any parts that are omitted shall be based on the known art.

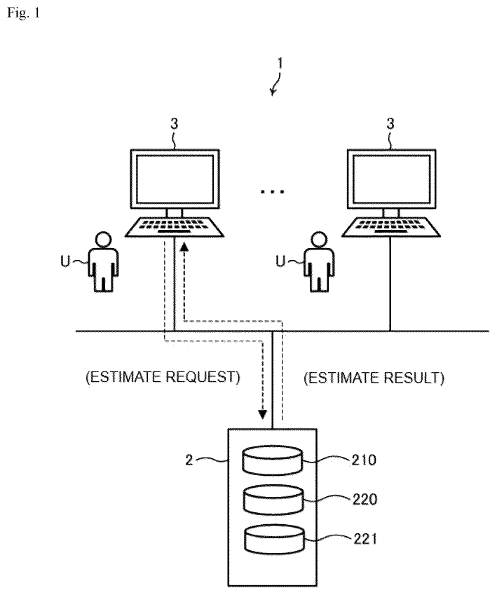

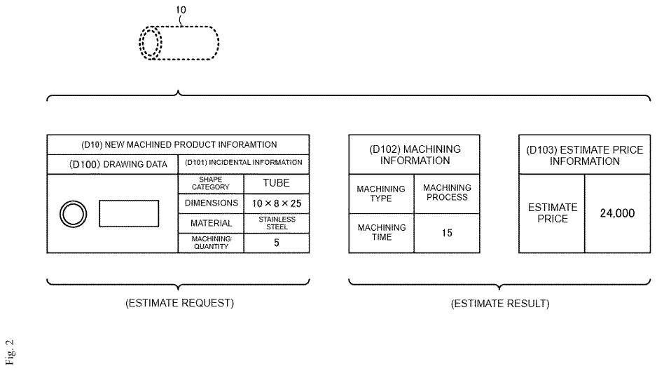

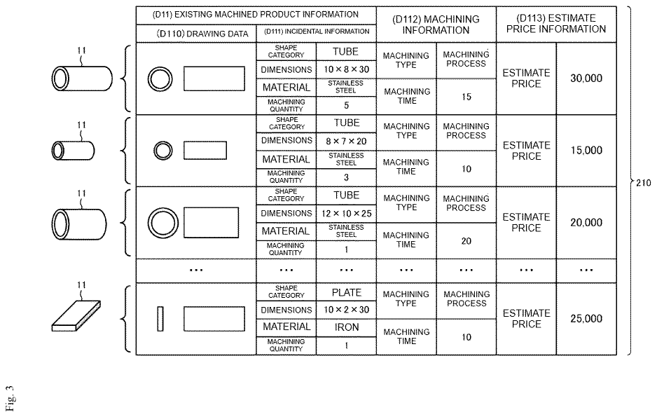

FIG. 1 is an overall configuration diagram of an example of an estimate creation support system 1 according to an embodiment. FIG. 2 is a diagram showing an example of various data related to a new machined product 10. FIG. 3 is a diagram showing an example of various data related to an existing machined product 11.

The estimate creation support system 1 is a system that accepts an estimate request from a user U and generates machining information D102 and estimation price information D103 as estimate results corresponding to when the new machined product 10 is machined according to drawing data D100 and incidental information D101. In addition, the estimate creation support system 1 registers and manages various information in a database 210 so that, when the estimate creation support system 1 generates the machining information D102 and the estimate price information D103 for the new machined product 10, the estimate creation support system 1 refers to machining information D112 and estimate price information D113 corresponding to when the existing machined product 11 is machined according to the drawing data D110 and the incidental information D111.

The machined products 10 and 11 are manufactured by one or more machining steps being performed on a raw material by various types of machining equipment or manual operations. Examples of the machined products 10 and 11 include machined products manufactured by machining, architectural products manufactured by construction machining, and garments manufactured by cutting and sewing machining. The machined products 10 and 11 are not limited to the above examples as long as they are machined by machining steps in accordance with the drawing data D100 and D110 and the incidental information D101 and D111. In this embodiment, description of the machined products 10, 11 will focus on a case where the machined products are mechanically machined products.

The user U can be, for example, a user who receives an order for a machining process for the new machined product 10 (machining company), or a user who orders the machining process for the new machined product 10 (ordering company).

As shown in FIG. 2, the main data to be input into the estimate creation support system 1 at the time of requesting an estimate is new machined product information D10, which includes the drawing data D100 and the incidental information D101 of the new machined product 10.

As shown in FIG. 3, the main data referred to by the estimate creation support system 1 at the time of requesting an estimate is existing machined product information D11, which includes the drawing data D110 and the incidental information D111 of the existing machined product 11, and machining information D112 corresponding to when the existing machined product 11 is machined according to the existing machined product information D11. These data are registered and stored in the database 210.

As shown in FIG. 2, the main data output as estimate results from the estimate creation support system 1 at the time of requesting an estimate are the machining information D102 corresponding to when the new machined product 10 is machined according to the new machined product information D10 and the estimate price information D103.

The drawing data D100 and D110 are data that record the plan and assembly drawings of the machined products 10 and 11, respectively. The drawing data D100 and D110 contain not only the outlines of the machined products 10 and 11 but also various lines such as center lines and dimension lines, as well as letters, numbers, symbols, and notes (not shown) to indicate the machining process.

The drawing data D100 and D110 may be 2D data (plan view, cross-sectional view, etc.) or 3D data (three-dimensional information), and may be in either vector format or raster format. The drawing data D100 and D110 may be CAD data (an example of the vector format) output by any type of CAD software, or image data (an example of the raster format) output by scanning a drawing printed on paper media. In a case where the data is 3D data, the data may be handled as 2D data through a conversion process that converts 3D data to 2D data. This embodiment will mainly deal with a case where the drawing data D100 and D110 are both 2D data.

The incidental information D101 and D111 are information that is created together with the drawing data D100 and D110 to supplement the information about the machined products 10 and 11, respectively. The incidental information D101 and D111 include at least one of the following as incidental items: shape category, dimensions, material, and machining quantity of the machined products 10 and 11, respectively. The incidental items of the incidental information D101 and D111 are not limited to the above examples as long as they indicate characteristics of the machined products 10 and 11, respectively, and details of the machining process.

The shape category is a classification of the external shape of the raw material before machining or the external shape of the machined product 10 or 11 after machining. Examples of the shape category include “plate”, “bar,” and “tube,” but no limitation is intended.

The dimensions are an expression of the external shape of the raw material before machining or the external shape of the machined product 10 or 11 after machining that uses two or more variables. Examples of the dimensions include three variables indicating width x length x thickness, three variables indicating outer diameter x inner diameter x length, and two variables indicating outer diameter x length, but no limitation is intended. Different dimensional expressions may be used depending on the shape category. For example, in a case where the shape category is “plate,” dimensional expressions based on the three variables indicating width x length x thickness can be used. Alternatively, in a case where the shape category is “bar” or “tube,” dimensional expressions based on the three variables indicating outer diameter x inner diameter x length can be used.

The material indicates the type of material of the raw material before machining. The material may be identified by either a formal name or an abbreviated name.

The machining information D102 and D112 includes at least one of a machining type, which defines the type of machining process used when the machined product 10 or 11 is machined by one or more machining processes, and machining time required for the machining process.

The machining type is defined as a classification of a combination or sequence of machining processes in a pattern. For example, in a case where there are two series of machining processes, such as “Setup→CAD→CAM→Machining→Finishing→Inspection→Packaging” and “Setup→CAD-CAM→Router machining→Finishing→Inspection→Packaging”, the machining types can be defined as “machining” and “router machining,” respectively. The classification of the machining type may be defined not only based on the machining equipment and manual labor used in the machining process but also by other methods. For example, the machining type may be defined based on the machining method, such as “forming machining,” “removal machining,” “addition machining,” etc.

The machining time may be an actual value acquired during actual machining, or a simulated value estimated by simulation. In a case where the machined product 10 or 11 is machined by multiple machining processes, the machining time may be the machining time for a singular machining process.

As shown in FIG. 1, the estimation creation support system 1 includes an information processing device 2 and a user terminal device 3. The information processing device 2 and the user terminal device 3 are connected to a wired or wireless network 4 and are configured to mutually send and receive various types of data. The number of information processing devices 2 and user terminal devices 3 and the connection configuration of these devices with the network 4 are not limited to the example shown in FIG. 1 and may be changed as required.

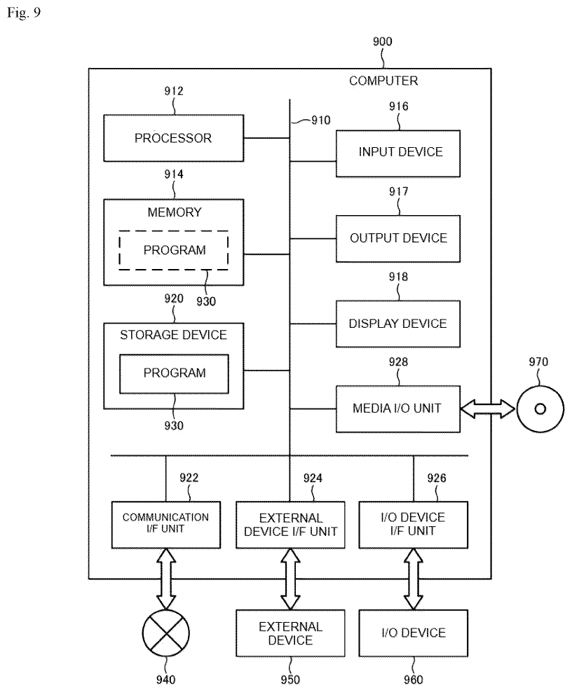

The information processing device 2 is a server-type computer or a cloud-type computer, and is composed of a general-purpose computer or a dedicated computer (see FIG. 9 described below), for example. The information processing device 2 performs machine learning of a feature inference model 220 and a machining information inference model 221. Using the learned feature inference model 220 and the learned machining information inference model 221, the information processing device 2 generates the machining information D102 and the estimation price information D103 as estimate results for an estimate request related to the new machined product 10.

The user terminal device 3 is a client-type computer and is composed of a general-purpose computer or a dedicated computer (see FIG. 9 described below), for example. The user terminal device 3 accepts various input operations via a display screen, such as an application or a browser, such that a user can input an estimate request or confirm the estimate results, and outputs various information via the display screen or sound.

### Configuration of Information Processing Device 2

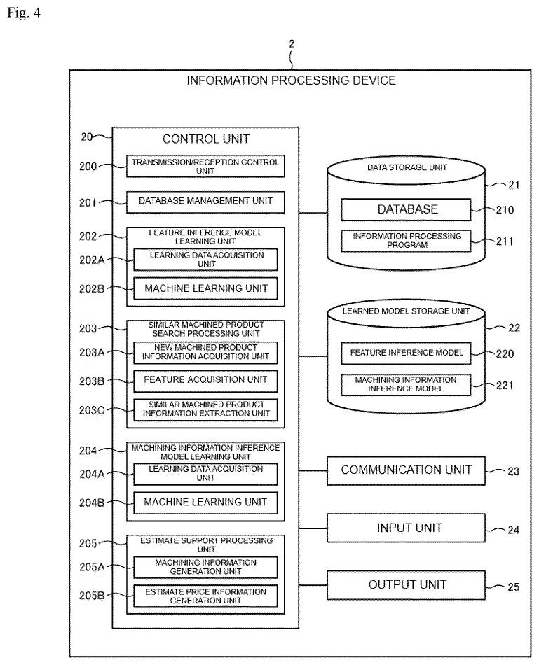

FIG. 4 is a block diagram showing an example of the information processing device 2.

The information processing device 2 includes a control unit 20, a data storage unit 21, a learned model storage unit 22, a communication unit 23, an input unit 24, and an output unit 25.

The communication unit 23 is connected to an external device (e.g., the user terminal device 3) via a network 4 and functions as a communication interface for sending and receiving various types of data. The input unit 24 and the output unit 25 function as a user interface by accepting various input operations and outputting various information via a display screen or sound, respectively. Note that, the input unit 24 and the output unit 25 may be omitted.

The data storage unit 21 stores the database 210 and an information processing program 211. As shown in FIG. 3, a plurality of pairs of the existing machined product information D11 including the drawing data D110 and the incidental information D111 of the existing machined product 11 and the machining information D112 corresponding to when the existing machined product 11 is machined according to the existing machined product information D11 are registered in the database 210 in association with each other. The specific configuration of the database 210 is not limited to the example of FIG. 3 and may be designed as required.

The learned model storage unit 22 stores a learned feature inference model 220 and a learned machining information inference model 221. The feature inference model 220 and the machining information inference model 221 stored in the learned model storage unit 22 may be provided to another device via the network 4, a recording media, or other means. The number of feature inference models 220 and machining information inference models 221 stored in the learned model storage unit 22 is not limited to one each, and multiple inference models with different conditions, such as different machine learning methods or different data, may be stored and used selectively or in parallel with one another.

In FIG. 3, the data storage unit 21 and the learned model storage unit 22 are shown as two storage units, but the data storage unit 21 and the learned model storage unit 22 may comprise a single storage unit or three or more storage units. Further, at least one of the data storage unit 21 and the learned model storage unit 22 may comprise a storage unit of an external computer (e.g., a server-based computer or a cloud-based computer).

The control unit 20 executes the information processing program 211 recorded in the data storage unit 21 to function as a transmission/reception control unit 200, a database management unit 201, a feature inference model learning unit 202, a similar machined product search processing unit 203, a machining information inference model learning unit 204, and an estimate support processing unit 205.

### Transmission/Reception Control Unit 200

The transmission/reception control unit 200 transmits/receives various types of data to/from an external device (e.g., the user terminal device 3). For example, the transmission/reception control unit 200 transmits, to the user terminal device 3, display information for outputting various display screens to the user terminal device 3 and receives, from the user terminal device 3, operation information for receiving input operations performed on the display screen of the user terminal device 3. Then, the transmission/reception control unit 200 coordinates with the database management unit 201, the feature inference model learning unit 202, the similar machined product search processing unit 203, the machining information inference model learning unit 204, and the estimate support processing unit 205 to transmit the display information and receive the operation information between these units.

### Database Management Unit 201

When the database management unit 201 receives the existing machined product information D11 and the machining information D112 related to the existing machined product 11 from the user terminal device 3, the database management unit 201 registers the existing machined product information D11 and the machining information D112 in the database 210 in association with each other. In addition, when the machining information D102 and the estimate price information D103 are generated by the estimate support processing unit 205 (details described below) for the new machined product 10, the database management unit 201 registers the machining information D102 and the estimate price information D103 in the database 210 in association with the new machined product information D10. This increases the number of data registered in the database 210 with each successive estimate, thereby improving machining accuracy.

Note that, the transmission/reception control unit 200 can refer to various information already registered in the database 210 from the user terminal device 3. At that time, editing operations such as adding, deleting, and modifying each piece of data may be performed on the display screen of the user terminal device 3. In addition, in the database 210, the information registered in association with the new machined product information D10 or the existing machined product information D11 is not limited to the machining information D102 and D112, and any information can be associated with the new machined product information D10 or the existing machined product information D11 as necessary. For example, the estimate price information D103 and D113, features of the new machined product information D10 or the existing machined product information D11 (details described below), or a user name, user affiliation (company name, etc.), estimate date and time, and estimate price related to the estimate request may be registered in the database 210, but no limitation is intended.

### Feature Inference Model Learning Unit 202

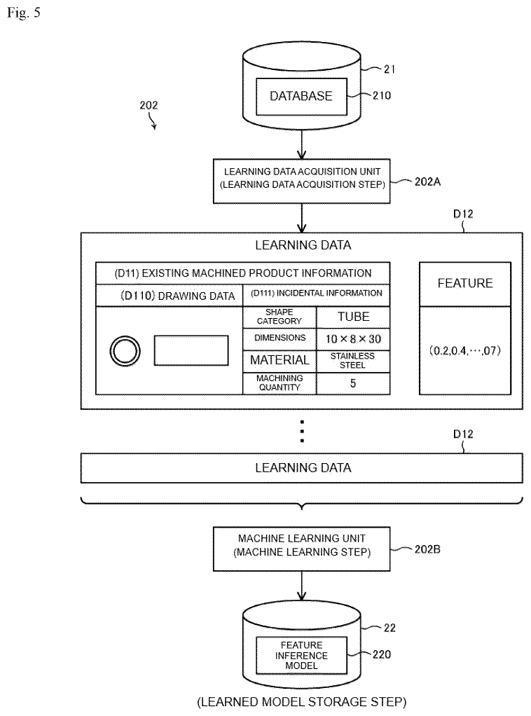

FIG. 5 is a functional illustration of an example of the feature inference model learning unit 202. The feature inference model learning unit 202 includes a learning data acquisition unit 202A and a machine learning unit 202B.

The learning data acquisition unit 202A references the database 210 and acquires learning data D12, which consists of input data and output data.

The input data comprising the learning data D12 is feature inference model input information based on at least the drawing data D110 of the existing machined product information D11. The feature inference model input information may be based on the drawing data D110 and the incidental information D111 included in the existing machined product information D11 and, for example, may include the drawing data D110 and the incidental information D111. The feature inference model input information may also include at least external shape data, which is a cutout of the area in which the external shape of the existing machined product 11 is described.

The output data comprising the learning data D12 are features of the existing machined product information D11. The features are defined, for example, as data in vector format by means of a fixed-length numerical array. The features are not limited to the vector format and may be defined in other data formats.

The learning data D12 is data used as teacher data (training data), validation data, and test data in supervised learning. The output data comprising the learning data D12 is the data used as the correct answer labels in supervised learning.

The learning data acquisition unit 202A may acquire the learning data D12 from data that is already registered in the database 210 and satisfies predetermined conditions. Also, the learning data acquisition unit 202A may acquire the learning data D12 by another method instead of or in addition to acquisition from the database 210.

For example, the learning data acquisition unit 202A may acquire the learning data D12 in cooperation with an external device connected via the network 4, or may acquire the learning data D12 by accepting input operations via the input unit 24 and the output unit 25.

The machine learning unit 202B performs machine learning to train the feature inference model 220 to learn the correlation between the input data and the output data using a plurality of sets of the learning data D12 acquired by the learning data acquisition unit 202A.

The machine learning unit 202B performs distance learning such that the distance between features when comparing them increases as the drawing data D110 become more similar to each other, or the distance between features when comparing them decreases as the drawing data D110 become less similar to each other. With this configuration, the feature inference model 220 is made to learn the correlation between the input data and the output data. The learned feature inference model 220 is stored in the learned model storage unit 22.

The feature inference model 220 is, for example, a model that uses a neural network, a vision transformer, or a hash algorithm, but no limitation is intended.

In a case where the input data (feature inference model input information) is the drawing data D110 (may be external shape data) in raster format, the feature inference model 220 may use an algorithm to acquire global features from all the drawing data D110, or may use an algorithm to extract local features from some of the drawing data D110 and use statistical information of the local features to acquire the overall features of the drawing data D110.

Alternatively, in a case where the input data is the drawing data D110 (may be external shape data) and the incidental information D111, the feature inference model 220 may consist of a single inference model that outputs features using both the drawing data D110 and the incidental information D111 as input data, or may consist of an inference model that uses the drawing data D110 as input data to output features and an inference model that uses the incidental information D111 as input data to output features, and then output final features by combining the features output by the two inference models.

Furthermore, as the feature inference model 220, for example, an inference model that has been pre-trained using a data set for general image recognition may be used, or an inference model with randomly initialized parameters may be used. In this case, the machine learning unit 202B may perform additional learning such as fine tuning or transition learning on the feature inference model 220. As the method of additional learning, the machine learning unit 202B may, for example, perform distance learning such that the distance between features when comparing them increases as the drawing data D110 become more similar to each other, or the distance between features when comparing them decreases as the drawing data D110 become less similar to each other. With this configuration, the feature inference model 220 can extract similar drawing data D110 by evaluating the distance between features. The method of machine learning is not limited to the above example and can be selected according to the feature inference model 220.

The timing at which the machine learning unit 202B performs the machine learning of the feature inference model learning unit 202 may be when the number of data newly registered in the database 210 exceeds a predetermined number, or when an instruction or request for an estimate is received from the user U, but no limitation is intended.

### Similar Machined product Search Processing Unit 203

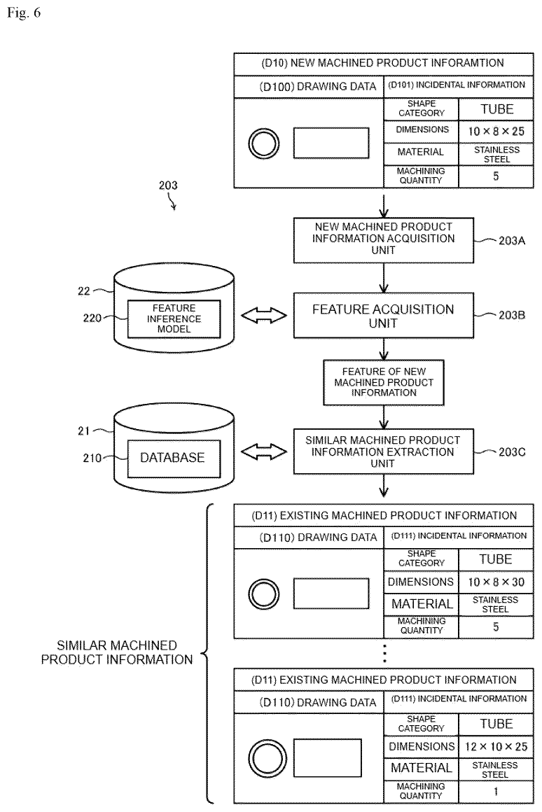

FIG. 6 is a functional illustration of an example of the similar machined product search processing unit 203. The similar machined product search processing unit 203 includes a new machined product information acquisition unit 203A, a feature acquisition unit 203B, and a similar machined product information extraction unit 203C.

The new machined product information acquisition unit 203A acquires the new machined product information D10 including the drawing data D100 and the incidental information D101 of the new machined product 10. The new machined product information acquisition unit 203A acquires the new machined product information D10 by, for example, receiving the new machined product information D10 from the user terminal device 3 as an estimate request related to the new machined product 10.

The new machined product information acquisition unit 203A may acquire some or all of the incidental information D101 from the drawing data D100 by reading letters, numbers, symbols, notes, or the like included in the drawing data D100. For example, in a case where text information is embedded in the drawing data D100, the new machined product information acquisition unit 203A acquires the incidental information D101 by reading the text information. Alternatively, the new machined product information acquisition unit 203A acquires the incidental information D101 by performing optical character recognition (OCR) on the drawing data D100 and reading the text information. At that time, the result that the incidental information D101 has been acquired may be displayed on the display screen of the user terminal device 3 and the user U may perform an editing operation.

The feature acquisition unit 203B acquires the features of the new machined product information D10 acquired by the new machined product information acquisition unit 203A by inputting the feature inference model input information based on at least the drawing data D100 into the feature inference model 220.

As the feature inference model 220, a model that has undergone machine learning by the feature inference model learning unit 202 and that is stored in the learned model storage unit 22 is used. The feature acquisition unit 203B performs preprocessing on the new machined product information D10 in accordance with the definition of input data in the feature inference model 220 and inputs the data into the feature inference model 220. The feature acquisition unit 203B may acquire the features of the existing machined product information D11 by inputting the feature inference model input information of the existing machined product information D11 based on at least the drawing data D110 into the feature value inference model 220 and register the features of the existing machined product information D11 in the database 210.

The similar machined product information extraction unit 203C extracts a plurality of sets of the existing machined product information D11 that is similar to the new machined product information D10 from the database 210 in which a plurality of sets of the existing machined product information D11, which includes the drawing data D110 and the incidental data D111 of the existing machined product 11, are registered on the basis of the features of the new machined product information D10 acquired by the feature value acquisition unit 203B. Here, among the plurality of sets of existing machined product information D11, the existing machined product information D11 similar to the new machined product information D10 is referred to as “similar machined product information D11”.

As the method of extracting the similar machined product information D11, the similar machined product information extraction unit 203C extracts the similar machined product information D11, for example, based on the degree of similarity between the features of the new machined product information D10 and the features of the existing machined product information D11 for each existing machined product 11 using the features of the existing machined product information D11.

In a case where the features of the existing machined product information D11 are registered in the database 210 in association with the existing machined product information D11, the similar machined product information extraction unit 203C need only extract the similar machined product information D11 based on the similarity between the features of the new machined product information D10 and the features of the existing machined product information D11 registered in the database 210. In a case where the features of the existing machined product information D11 are not registered in the database 210 in association with the existing machined product information D11, the feature acquisition unit 203B need only input the feature inference model input information based on at least the drawing data D110 of the existing machined product information D11 into the feature value inference model 220 to acquire the feature of the existing machined product information D11, and the similar machined product information extraction unit 203C need only extract the similar machined product information D11 based on the similarity between the feature of the new machined product information D10 and the feature of the existing machined product information D11 acquired by the feature acquisition unit 203B.

The similarity is defined, for example, by the distance between the features when they are compared. In a case where the features are defined in vector form data, the distance between the features can be, for example, distance indices such as Euclidean distance, Manhattan distance, Chebyshev distance, and Mahalanobis distance, and similarity indices such as cosine similarity can be used, but no limitation is intended.

The method of extracting the similar machined product information D11 from the database 210 and the number of extractions can be set as desired. For example, a predetermined number or a predetermined percentage of the existing machined product information D11 may be extracted as the similar machined product information D11 on the basis of increasing similarity. Alternatively, a predetermined number or a predetermined percentage of the existing machined product information D11 based on increasing similarity may be considered candidates, and then the existing machined product information D11 may be narrowed down or the ranking of similarity may be reordered on the basis of the incidental information D101 contained in the new machined product information D10 and the incidental information D111 contained in the existing machined product information D11. Then, based on that result, the predetermined number or predetermined percentage of the existing machined product information D11 may be extracted as the similar machined product information D11. The method for narrowing down is not particularly limited and may be, for example, a method of narrowing down the data to only those candidates where certain incidental items in the incidental information D101 (e.g., shape category) among the incidental information D101 match, or a method of using a specific incidental item (e.g., dimension) in the incidental information D101 as a reference and narrowing down the data to only those candidates included within a predetermined range from the standard. The method for reordering is not particularly limited and may be, for example, a method in which the ranking of candidates whose specific incidental items match among the incidental information D101 is made higher.

The similar machined product information extraction unit 203C may limit the search range of the database 210 on the basis of at least the incidental information D101 of the new machined product information D10, and extract the similar machined product information D11 from the database 210 with a limited search range on the basis of the features of the new machined product information D10.

The method of limiting the search range of the database 210 is not particularly limited and may be, for example, a method of limiting the search range of the database 210 such that the existing machined product information D11 for which incidental items (e.g., shape category) in the incidental information D101 match is extracted. With this configuration, the existing machined product D11, which differs significantly in characteristics from the new machined product 10, can be removed from the search range, meaning that the similar machined product information D11 can be extracted with a higher degree of accuracy.

### Machining information Inference Model Learning Unit 204

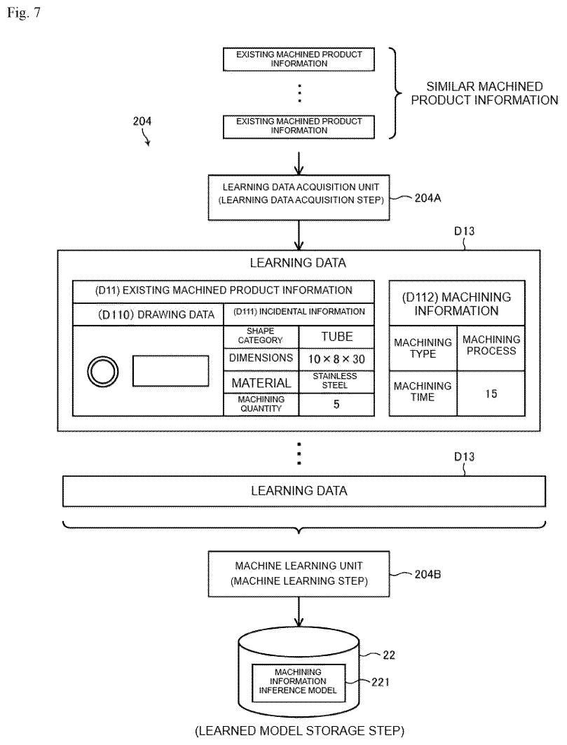

FIG. 7 is a functional illustration of an example of the machining information inference model learning unit 204. The machining information inference model learning unit 204 includes a learning data acquisition unit 204A and a machine learning unit 204B.

The learning data acquisition unit 204A references the database 210 and acquires learning data D13, which consists of input data and output data.

The input data comprising the learning data D13 is machining information inference model input information based on the existing machined product information D11. The machining information inference model input information may be at least one of the drawing data D110 and the incidental information D111 included in the existing machined product information D11, or may be based on at least one of the drawing data D110 and the incidental information D111. In that case, only some of the incidental items of the incidental information D111 may be selected for use. For example, in a case where the incidental items of the incidental information D111 include shape category, dimensions, material, and machining quantity, only the shape category, dimensions, and material may be used as the machining information inference model input information. The machining information inference model input information may also be the features of the existing machined product information D11. Furthermore, in a case where the features of the existing machined product information D11 are data in the vector format, the machining information inference model input information may be the features of the existing machined product information D11 reduced in dimension by methods such as principal component analysis, independent principal component analysis, and non-negative matrix factorization.

The output data comprising the learning data D13 is the machining information D112 corresponding to when the existing machined product 11 is machined according to the existing machined product information D11.

The learning data D13 is data used as teacher data (training data), validation data, and test data in supervised learning. The output data comprising the learning data D13 is data used as correct answer labels in supervised learning.

When the similar machined product search processing unit 203 extracts a plurality of sets of the similar machined product information D11 for the new machined product information D10 in the estimate request, the learning data acquisition unit 204A uses the machining information inference model input information based on the similar machined product information D11 for each of the plurality of sets of similar machined product information D11 as input data, and uses the machining information D112 associated with the similar machined product information D11 as output data, thereby acquiring a plurality of sets of the learning data D13.

In this case, in a case where the features of the existing machined product information D11 are used as the machining information inference model input information, and in a case where the features of the existing machined product information D11 are registered in the database 210 in association with the existing machined product information D11, the learning data acquisition unit 204A need only acquire the learning data D13 by referring to the features of the existing machined product information D11 registered in the database 210. In a case where the features of the existing machined product information D11 are not registered in the database 210 in association with the existing machined product information D11, the feature acquisition unit 203B need only input feature inference model input information based on at least the drawing data D110 of the existing machined product information D11 into the feature inference model 220 to acquire the features of the existing machined product information D11, and the learning data acquisition unit 204A need only acquire the learning data D13 on the basis of the features of the existing machined product information D11 acquired by the feature acquisition unit 203B.

The machine learning unit 204B performs machine learning such that the machining information inference model 221 learns the correlation between the input data and the output data by using a plurality of sets of the learning data D13 acquired by the learning data acquisition unit 204A. The learned machining information inference model 221 is stored in the learned model storage unit 22.

The plurality of sets of learning data D13 used for machine learning of the machining information inference model 221 are acquired based on a plurality of sets the similar machined product information D11 that is similar to the new machined product information D10 in the estimate request. This makes it possible to start using the estimate creation support system 1 with a small amount of learning data D13, eliminating the need to prepare a large amount of the learning data D13 in advance for the machining information inference model 221 to perform machine learning before starting to use the estimate creation support system 1. In addition, since the machining information inference model 221 performs machine learning using the similar machined product information D11 that is relatively similar to the new machined product information D10 in the estimate request, compared to a case where the similarity between the new machined product information D10 and the existing machined product information D11 is not considered, the inference accuracy of the machining information inference model 221 can be improved because the machining information inference model 221 is less affected by the existing machined product 11 whose characteristics differ significantly from the new machined product 10.

The machining information inference model 221 can be, for example, a model using a linear model, a support vector machine, a decision tree model, a K-nearest neighbor algorithm, or a neural network, but no limitation is intended. The method of machine learning can be selected as appropriate for the feature inference model 220. The machining information inference model 221 is constructed as a classification model in a case where the machining information D102 outputs a categorical value, such as machining type, and as a regression model in a case where the machining information D102 outputs a scalar value, such as machining time.

### Estimation Support Processing Unit 205

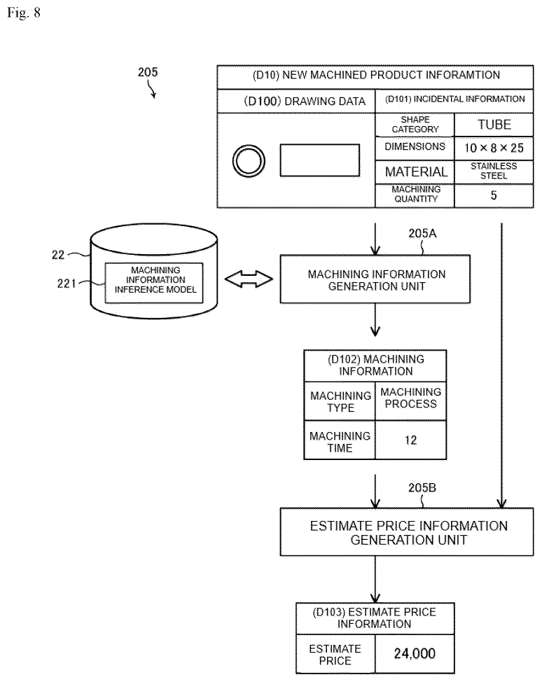

FIG. 8 is a functional illustration of an example of the estimation support processing unit 205. The estimate support processing unit 205 includes a machining information generation unit 205A and an estimate price information generation unit 205B.

The machining information generation unit 205A generates the machining information D102 for the new machined product information D10 by inputting the machining information inference model input information based on the new machined product information D10 acquired by the new machined product information acquisition unit 203A into the machining information inference model 221 that has been trained by the machining information inference model learning unit 204.

As the machining information inference model 221, a model that has undergone machine learning by the machining information inference model learning unit 204 and that is stored in the learned model storage unit 22 is used. In other words, the machining information inference model 221 undergoes machine learning using a plurality of sets of the similar machined product information D11 that is similar to the new machined product information D10 in the estimate request. The machining information generation unit 205A generates the machining information D102 for the new machined product information D10 by pre-processing the new machined product information D10 and inputting the new machined product information D10 into the feature inference model 220 according to the definition of input data in the machining information inference model 221.

The estimation price information generation unit 205B generates the estimation price information D103 for the new machined product information D10 on the basis of the incidental information D101 included in the new machined product information D10 acquired by the new machined product information acquisition unit 203A and the machining information D102 generated by the machining information generation unit 205A.

The method by which the estimate price information generation unit 205B calculates the estimate price is not particularly limited and may be, for example, a method of adding up the amounts for each expense item such as material cost, machining cost, general administrative selling cost, and profit. In this case, the material cost reflects the material and the machining quantity in the supplementary information D101, and the machining cost reflects the machining type and the machining time in the machining information D102.

The machining information D102 generated by the machining information generation unit 205A and the estimate price information D103 generated by the estimate price information generation unit 205B are, for example, transmitted to the database management unit 201 and registered in the database 210 in association with the new machined product information D10.

In addition, the machining information D102 generated by the machining information generation unit 205A and the estimate price information D103 generated by the estimate price information generation unit 205B are displayed on the user terminal device 3 by the transmission/reception control unit 200. At this time, the machining information D102 and the estimate price information D103 may be edited, or for example, be corrected on the display screen of the user terminal device 3.

### Hardware Configuration of Each Device

FIG. 9 is a hardware configuration diagram of an example of the computer 900. The information processing device 2 and the user terminal device 3 in the estimate creation support system 1 are each configured by a general-purpose or dedicated computer 900.

As shown in FIG. 9, the computer 900 includes, as major components, a bus 910, a processor 912, a memory 914, an input device 916, an output device 917, a display device 918, a storage device 920, a communication interface (I/F) unit 922, an external device I/F unit 924, an input/output (I/O) device I/F unit 926, and a media I/O unit 928. Note that, the above components may be omitted as appropriate depending on the application in which the computer 900 is used.

The processor 912 is configured by one or more arithmetic processing units (central processing unit (CPU), micro-processing unit (MPU), digital signal processor (DSP), graphics processing unit (GPU), etc.) and operates as a control unit that controls the entire computer 900. The memory 914 stores various data and programs 930, and is configured by, for example, a volatile memory (DRAM, SRAM, etc.) that functions as the main memory and a non-volatile memory (ROM) or a flash memory.

The input device 916 is configured by, for example, a keyboard, a mouse, a numeric keypad, an electronic pen, or a microphone, and functions as an input unit. The output device 917 is configured by, for example, a sound (voice) output device or a vibration device, and functions as an output unit. The display device 918 is configured by, for example, a liquid crystal display, an organic EL display, electronic paper, or a projector, and functions as an output unit. The input device 916 and the display device 918 may be configured integrally, for example, as a touch panel display. The storage device 920 is configured by, for example, an HDD, an SSD, and functions as a storage unit. The storage device 920 stores various data necessary for executing the operating system and the program 930.

The communication I/F unit 922 is wired or wirelessly connected to a network 940 such as the Internet or an intranet (which may be the same as the network 4 in FIG. 1) and functions as a communication unit that sends/receives data to/from another computer in accordance with a predetermined communication standard. The external device I/F unit 924 is wired or wirelessly connected to an external device 950 such as a camera, a printer, a scanner, or a reader/writer. Further, the external device I/F unit 924 functions as a communication unit that transmits/receives data to/from the external device 950 according to a predetermined communication standard. The I/O device I/F unit 926 is connected to an I/O device 960 such as a sensor or an actuator, and functions as a communication unit that transmits/receives various signals and data such as detection signals by sensors and control signals to actuators, to/from the I/O device 960. The media I/O unit 928 is configured by, for example, a drive device such as a DVD drive or a CD drive, and reads/writes data to/from a medium (non-transient storage media) 970 such as a DVD or a CD.

In the computer 900 having the above configuration, the processor 912 calls and executes the program 930 stored in the storage device 920 to the memory 914 and controls various parts of the computer 900 via the bus 910. The program 930 may be stored in the memory 914 instead of in the storage device 920. The program 930 may be recorded on the medium 970 in an installable file format or an executable file format and may be provided to the computer 900 via the media I/O unit 928. The program 930 may be provided to the computer 900 by being downloaded via the network 940 via the communication I/F unit 922. The computer 900 may also be a hardware realization of various functions realized by the processor 912 executing the program 930, such as, for example, an FPGA or ASIC.

The computer 900 may be configured by, for example, a stationary computer or a portable computer, which may be any form of electronic device. The computer 900 may be a client computer, a server computer, or a cloud computer, or may be an embedded computer referred to as a control distribution board or a controller (including a microcontroller, a programmable logic controller, and a sequencer).

### Operation of Information Processing Device 2

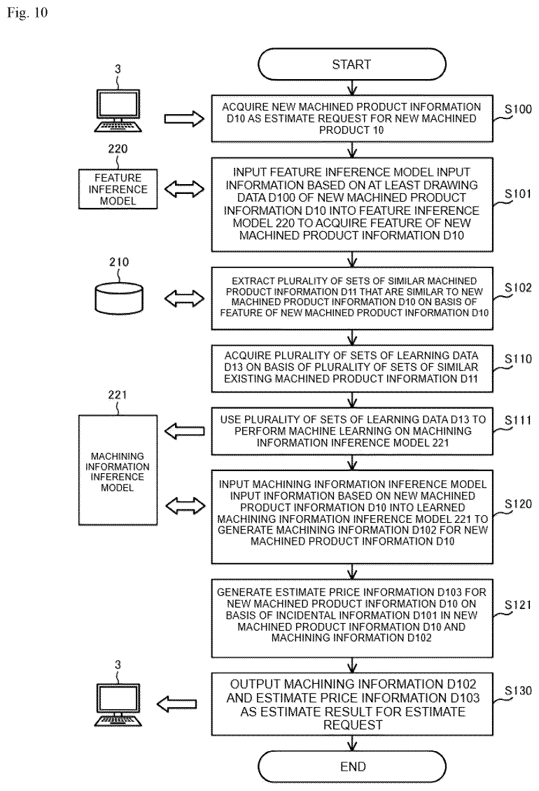

FIG. 10 is a flowchart showing an example of the operation (information processing method) of the information processing device 2. In the following description, the series of steps in the information processing method performed by the information processing device 2 shown in FIG. 10 are executed when the information processing device 2 receives an estimate request for the new machined product 10 from the user terminal device 3 operated by the user U. Further, in the following description, the existing machined product information D11 and the machining information D112 are registered in the database 210 for a plurality of the existing machined products 11 by the database management unit 201. Additionally, in the following description, the learned feature inference model 220 is stored in the learned model storage unit 22 by the feature inference model learning unit 202 by way of the learned feature inference model 220 performing a learning data acquisition step, a machine learning step, and a learned model storage step are performed, as shown in FIG. 5.

First, in step S100 (new machined product information acquisition step), the new machined product information acquisition unit 203A of the similar machined product search processing unit 203 acquires the new machined product information D10 by receiving the new machined product information D10 from the user terminal device 3 as an estimate request for the new machined product 10. In this case, the new machined product information D10 includes the drawing data D100 and the incidental information D101 of the new machined product 10.

In step S101 (feature acquisition step), the feature acquisition unit 203B acquires the features of the new machined product information D10 by inputting the feature inference model input information based on at least the drawing data D100 of the new machined product information D10 acquired in step S100 to the feature inference model 220.

In step S102 (similar machined product information extraction step), the similar machined product information extraction unit 203C extracts a plurality of sets of the similar machined product information D11 (existing machined product information D11) that are similar to the new machined product information D10 from the database 210, in which a plurality of sets of the existing machined product information D11 are registered, on the basis of the features of the new machined product information D10 acquired in step S101.

In step S110 (learning data acquisition step), the learning data acquisition unit 204A of the machining information inference model learning unit 204 uses the machining information inference model input information based on the similar machined product information D11 as input data and uses the machining information D112 associated with the similar machined product information D11 as output data, to thereby acquire a plurality of sets of the learning data D13 on the basis of the plurality of sets of similar machined product information D11 extracted in step S102.

In step S111 (machine learning step), the machine learning unit 204B performs machine learning to cause the machining information inference model 221 to learn the correlation between the input data (machining information inference model input information) and the output data (machining information D112) by using the plurality of sets of learning data D13 acquired in step S110.

In step S120 (machining information generation step), the machining information generation unit 205A inputs the machining information inference model input information based on the new machined product information D10 acquired in step S100 into the machining information inference model 221 that has undergone machine learning in step S111, to thereby generate the machining information D102 for the new machined product information D10.

In step S121 (estimate price information generation step), the estimate price information generation unit 205B generates the estimate price information D103 for the new machined product information D10 on the basis of the incidental information D101 included in the new machined product information D10 acquired in step S100 and the machining information D102 generated in step S120.

In step S130 (estimate result output step), the transmission/reception control unit 200 transmits the machining information D102 generated in step S120 and the estimate price information D103 generated in step S121 to the user terminal device 3. As a result, the machining information D102 and the estimate price information D103 are displayed on the display screen of the user terminal device 3 as an estimate result for the estimate request.

As described above, with the information processing device 2 and the information processing method according to this embodiment, the existing machined product information D11 that is similar to the new machined product information D10 is extracted by the similar machined product information extraction unit 203C on the basis of the features of the new machined product information D10, such that the machining information inference model 221 can perform machine learning using the learning data D13 suitable for the new machined product 10. Thus, compared to a case where similarity between the new machined product 10 and the existing machined product 11 is not considered, the inference accuracy of the machining information inference model 221 can be improved because the machining information inference model 221 is less affected by the existing machined product 11 whose characteristics differ significantly from the new machined product 10. Accordingly, the machining information D102 for the new machined product 10 can be accurately generated without relying on the knowledge and experience of a skilled worker.

### Other Embodiments

The present invention is not limited to the embodiments described above and can be implemented with various modifications within the scope that does not depart from the main purpose of the invention. All such modifications are included in the technical concept of the present invention.

In the above-described embodiment, the information processing device 2 consists of a single device, but the information processing device 2 may also consist of multiple devices. For example, the information processing device 2 may include units 202 to 205 that are distributed across multiple devices to include a machine learning device that includes the feature inference model learning unit 202 and performs the feature inference model learning step, an information processing device that includes the similar machined product search processing unit 203 and performs the similar machined product search processing step, a machine learning device for the machining information inference model 221 that includes the machining information inference model learning unit 204 and performs the machining information inference model learning step, and an information processing device that includes the estimate support processing unit 205 and performs the estimate support machining process may be configured. With this configuration, each unit (each step) provided by each of the above devices may be realized by a program (information processing program or machine learning program) executable by the computer 900.

Each of the above devices can be configured as follows, for example. The configuration and operation of each unit in each device and the various data handled by each device are the same as in the above-described embodiment, so detailed description will be omitted.

The machine learning device that performs the feature inference model learning step includes the learning data acquisition unit 202A that acquires a plurality of sets of the learning data D12 configured of input data and output data, the machine learning unit 202B that causes the feature inference model 220 to learn the correlation between the input data and the output data by using the plurality of sets of learning data D12 acquired by the learning data acquisition unit 202A, and the learned model storage unit 22 that stores the feature inference model 220 that was made to learn the correlation by the machine learning unit 202B. The input data is feature inference model input information based on at least the drawing data D110 of the existing machined product information D11. The output data is the features of the existing machined product information D11.

The information processing device that performs the similar machined product search processing step includes the new machined product information acquisition unit 203A that acquires the new machined product information D10, and the feature acquisition unit 203B that acquires the features of the new machined product information by inputting the feature inference model input information based on at least the drawing data D100 of the new machined product information D10 acquired by the new machined product information acquisition unit 203A into the feature inference model 220, and the similar machined product information extraction unit 203C that extracts one or more sets of the existing machined product information D11 that is similar to the new machined product information D10 on the basis of the features of the new machined product information D10 acquired by the feature acquisition unit 203B. The similar machined product information extraction unit 203C may be omitted.

The machine learning device that performs the machining information inference model learning step includes the learning data acquisition unit 204A that acquires a plurality of sets of the learning data D13 configured of input data and output data, the machine learning unit 204B that causes the machining information inference model 221 to learn the correlation between the input data and the output data by using the plurality of sets of learning data D13 acquired by the learning data acquisition unit 204A, and the learned model storage unit 22 that stores the machining information inference model 221 that was made to learn the correlation by the machine learning unit 204B. The input data is machining information inference model input information based on the existing machined product information D11. The output data is the machining information D112 corresponding to when the machined product 10 is machined according to the existing machined product information D11.

The information processing device that performs the estimation support processing step includes the new machined product information acquisition unit that acquires the new machined product information D10, the machining information generation unit 205A that generates the machining information D102 corresponding to when the new machined product 10 is machined in accordance with the new machined product information D10 by inputting machining information inference model input information based on the new machined product information D10 acquired by the new machined product information acquisition unit into the machining information inference model 221, and the estimate price information generation unit 205B that generates the estimate price information D103 for the new machined product information D10 on the basis of the incidental information D101 included in the new machined product information D10 acquired by the new machined product information acquisition unit and the machining information D102 generated by the machining information generation unit 205A. The estimate price information generation unit 205B may be omitted.

The transmission/reception control unit 200 and the database management unit 201 may be provided in each of the above devices. Further, the database 210 may be accessible from each of the above devices, or may be stored in a storage unit of any of the above devices or in a storage unit of an external computer. Additionally, some of the above devices may be realized in the user terminal device 3.

### Inference Device, Inference Method and Inference Program

The present invention may be provided not only in the form of the information processing device 2 (information processing method or information processing program) of the above-described embodiment, but also in the form of an inference device (inference method or inference program) used for inference about the features of the new machined product information D10 and the machining information D102. With this configuration, the inference device (inference method or inference program) can include a memory and a processor, of which the processor executes a series of processing. Here, the series of processing includes an information acquisition process for acquiring new machined product information D10 (information acquisition step) and, when the new machined product information D10 is acquired in the information acquisition process, inferring features of the new machined product information D10 (inference step). The series of processing also includes an information acquisition process for acquiring the new machined product information D10 (information acquisition step), and, when the new machined product information D10 is acquired by the information acquisition process, an inference process for inferring the machining information D102 corresponding to when the new machined product 10 is machined according to the new machined product information D10.

By providing the present invention in the form of an inference device (inference method or inference program), the present invention can be applied to a variety of devices more easily than when implementing the present invention as an information processing device. It is naturally understood by those skilled in the art that when the inference device (inference method or inference program) infers the features of the new machined product information D10 and the machining information D102, the inference method performed by the information generation unit may be applied using the learned inference model generated by the machine learning device and the machine learning method according to the above-described embodiment.

### REFERENCE SIGNS LIST

1 Estimate creation support system
2 Information processing device
3 User terminal device
10 New machined product
11 Existing machined product
20 Control unit
21 Data storage unit
22 Learned model storage unit
23 Communication unit
24 Input unit
25 Output unit
200 Transmission/reception control unit
201 Database management unit
202 Feature inference model learning unit
202A Learning data acquisition unit
202B Machine learning unit
203 Similar product search processing unit
203A New machined product information acquisition unit
203B Feature acquisition unit
203C Similar machined product information extraction unit
204 Machining information inference model learning unit
204A Learning data acquisition unit
204B Machine learning unit
205 Support processing unit
205A Machining information generation unit
205B Price information generation unit
210 Database
211 Information processing program
220 Feature inference model
221 Machining information inference model

1. An information processing device comprising:
a new machined product information acquisition unit configured to acquire new machined product information including drawing data and incidental information of a new machined product;
a feature acquisition unit configured to input feature inference model input information based on at least the drawing data of the new machined product information acquired by the new machined product information acquisition unit into a feature inference model to acquire a feature of the new machined product information;
a similar machined product information extraction unit configured to extract, from a database in which a plurality of sets of existing machined product information including drawing data and incidental data of an existing machined product and machining information corresponding to when the existing machined product is machined according to the existing machined product information are registered in association with each other, a plurality of sets of the existing machined product information that are similar to the new machined product information on the basis of the feature of the new machined product information acquired by the feature acquisition unit;
a machining information inference model learning unit configured to cause a machining information inference model to learn, by machine learning, a correlation between machining information inference model input information and the machining information by using a plurality of sets of learning data configured of the machining information inference model input information based on the existing machined product information extracted by the similar machined product information extraction unit and the machining information associated with the existing machined product information; and
a machining information generation unit configured to input machining information inference model input information based on the new machined product information acquired by the new machined product information acquisition unit into the machining information inference model that has been caused to learn by the machining information inference model learning unit to generate the machining information for the new machined product information.

2. The information processing device according to claim 1, further comprising:
an estimate price information generation unit configured to generate estimate price information for the new machined product information on the basis of the incidental information included in the new machined product information acquired by the new machined product information acquisition unit and the machining information generated by the machining information generation unit.

3. The information processing device according to claim 1, wherein the similar machined product information extraction unit extracts a plurality of sets of the existing machined product information that are similar to the new machined product information on the basis of similarity between the feature of the new machined product information and a feature of the existing machined product information registered in the database in association with the existing machined product information, or similarity between the feature of the new machined product information and a feature of the existing machined product information acquired by inputting feature inference model input information based on at least the drawing data of the existing machined product information into the feature inference model.

4. The information processing device according to claim 1, wherein the similar machined product information extraction unit
limits a search range of the database on the basis of at least the incidental information of the new machined product information acquired by the new machined product information acquisition unit, and
after the search range of the database is limited, extracts, from the database, a plurality of sets of the existing machined product information that are similar to the new machined product information on the basis of the feature of the new machined product information acquired by the feature value acquisition unit.

5. The information processing device according to claim 1, wherein the feature inference model is a learned inference model that has been subject to machine learning to learn a correlation between feature inference model input information based on at least the drawing data of the existing machined product information and the feature of the existing machined product information.

6. The information processing device according to claim 1, wherein
the feature inference model is a learned inference model that has been subjected to machine learning to learn a correlation between feature inference model input information that includes at least external shape data from which an area in which an external shape of the existing machined product is described has been cut out and the feature of the existing machined product information, and
the feature acquisition unit generates the external shape data from the drawing data by cutting out the area in which the external shape of the new machined product is described, and inputs feature inference model input information that includes at least the external shape data into the feature inference model, to thereby acquire the feature of the new machined product information.

7. The information processing device according to claim 1, wherein
the feature inference model input information based on at least the drawing data of the existing machined product information is based on the drawing data and the incidental information included in the existing machined product information, and
the feature inference model input information based on at least the drawing data of the new machined product information is based on the drawing data and the incidental information included in the new machined product information.

8. The information processing device according to claim 1, wherein
the machining information inference model input information based on the existing machined product information is a feature of the existing machined product information, and
the machining information inference model input information based on the new machined product information is a feature of the new machined product information.

9. The information processing device according to claim 1, wherein the incidental information includes at least one of a shape category, a dimension, a material, and a machining quantity of the existing machined product or the new machined product.

10. The information processing device according to claim 1, wherein
the machining information includes at least one of a machining type defining a type of the machining process corresponding to when the existing machined product or the new machined product is machined by one or more of the machining steps, and a machining time required for the machining process.

11. An information processing method comprising:
a new machined product information acquisition step of acquiring new machined product information including drawing data and incidental information of a new machined product;
a feature acquisition step of inputting feature inference model input information based on at least the drawing data of the new machined product information acquired by the new machined product information acquisition step into a feature inference model to acquire a feature of the new machined product information;
a similar machined product information extraction step of extracting, from a database in which a plurality of sets of existing machined product information including drawing data and incidental data of an existing machined product and machining information corresponding to when the existing machined product is machined according to the existing machined product information are registered in association with each other, a plurality of sets of the existing machined product information that are similar to the new machined product information on the basis of the feature of the new machined product information acquired by the feature acquisition step;
a machining information inference model learning step of causing a machining information inference model to learn, by machine learning, a correlation between machining information inference model input information and the machining information by using a plurality of sets of learning data configured of the machining information inference model input information based on the existing machined product information extracted by the similar machined product information extraction step and the machining information associated with the existing machined product information; and
a machining information generation step of inputting machining information inference model input information based on the new machined product information acquired by the new machined product information acquisition step into the machining information inference model that has been caused to learn by the machining information inference model learning step to generate the machining information for the new machined product information.
